(19) United States
(12) Patent Application Publication
(10) Pub. No.: US 2021/0214490 A1
(43) Pub. Date: Jul. 15, 2021

(54) FLAME-RETARDANT POLYMER; METHOD FOR PREPARING IT AND THERMOPLASTIC POLYMER COMPOSITION COMPRISING IT

(71) Applicant: PolyTechnyl, SAS, Paris (FR)

(72) Inventor: Thierry Badel, Lyon (FR)

(73) Assignee: PolyTechnyl, SAS, Paris (FR)

(21) Appl. No.: 16/608,722

(22) PCT Filed: Apr. 5, 2018
(86) PCT No.: PCT/EP2018/058690

§ 371 Date: Oct. 25, 2019

(30) Foreign Application Priority Data
Apr. 25, 2017 (EP) 17167935.0

(51) Int. Cl. C08G 63/692; C09K 21/14

(52) U.S. Cl. CPC C08G 63/6926; C09K 21/14

(57) ABSTRACT

The invention relates to a polymer which is useful as flame-retardant polymer. The invention also relates to a method of preparing said polymer and to a thermoplastic polymer composition comprising said polymer. The thermoplastic polymer composition can be used for the production of molded articles having excellent flame-retardant properties in order to ensure adequate fire protection.

### TECHNICAL FIELD OF THE INVENTION

The invention relates to a polymer which is useful as flame-retardant polymer. The invention also relates to a method of preparing said polymer and to a thermoplastic polymer composition comprising said polymer. The thermoplastic polymer composition can be used for the production of molded articles having excellent flame-retardant properties in order to ensure adequate fire protection.

### BACKGROUND

Flame-retardant polymer compositions are useful for the production of molded articles in a large number of application fields because of their excellent property profile. In many applications, it is important that the polymer composition has excellent flame-retardant properties in order to ensure adequate fire protection. In addition, it is, however, also important that the further physical properties, such as e.g. tensile modus, tear strength and breaking elongation, fulfill the prescribed requirements for the respective application cases.

While it is possible to impart fire-retardant properties to a polymer by incorporating certain monomers within the polymer backbone, this approach has the disadvantage that there is no flexibility with regard to the specific polymer composition for final use. Therefore, flame retardants are usually added to polymeric materials to enhance the flame-retardant properties of the polymers. This approach provides high flexibility with regard to the polymeric materials although there are also limitations with respect to the required compatibility of the used flame retardant with the polymeric materials. Furthermore, for the production of flame-retardant thermoplastic polymers, it is desirable for economic reasons to use non-reactive flame retardants, since the latter can be introduced into a base polymer by a simple physical mixing or dissolution. In contrast thereto, the production of flame-retardant thermoplastic polymers using reactive flame retardants always requires at least one or more chemical process steps which are usually carried out already during the production of the base polymer.

For the production of thermoplastic polymer compositions finished to be flame-retarding, a large number of non-reactive flame-retardants has already been in technical use for a long time. However, these are based in most cases on halogen- or antimony-containing substances which recently have come under public criticism due to their negative eco- and genotoxicologic potential. For this reason, halogen- and antimony-free non-reactive flame retardants are increasingly used, such as, e.g., red phosphor, melamine polyphosphate, melamine cyanurate or aluminum phosphinates, as are described in EP-A 1 070 454.

However, the aforementioned flame retardants are only partly suitable for use in melt spinning processes employed for the production of polyamide or polyester fibers. The halogenated flame retardants can considerably damage the spinning nozzle under the temperature and pressure conditions used during spinning. In contrast thereto, melamine polyphosphate, melamine cyanurate or aluminum phosphinates are only insufficiently soluble in polyamides or polyesters, which results in an inhomogeneous distribution of the flame retardant in the base polymer. This leads to considerable drawbacks in particular in the melt-spinning process, since a clogging of the spinning nozzle is caused.

Phosphoric flame retardants, which are obtained by addition reaction of 9,10-dihydro-9-oxa-10-phosphaphenanthrene-10-oxide (DOPO) to an unsaturated compound having at least one ester forming functional group, and by further reaction with an esterifying compound, which is selected from dicarboxylic acids, diols and oxycarboxylic acids are disclosed in US 2008/0300349 A1, US 2010/0181696 A1, US 2013/0136911 A1, CN-A 104211954 and WO 2008/119693 A1. It is said that these halogen-free flame retardants are not toxic and can be processed easily together with thermoplastic molding compositions at high temperatures in a melt-spinning process or other extrusion processes.

WO 2013/139877 A1discloses phosphorous-containing unsaturated polyesters, polyester resins and optionally fire-reinforced components therefrom.

The unsaturated polyesters comprise monomers derived from DOPO derivatives. However, these unsaturated polyesters are not intended to be mixed with other polymer bases for imparting flame-retardant properties to the composition but are rather used to produce thermoset moldings by cross-linking the unsaturated polyesters. Furthermore, these polyesters are, if at all, hardly suitable in melt-spinning or other extrusion processes together with a thermoplastic base polymer because the unsaturated carboxylic acid monomers in these unsaturated polyesters are unstable at higher temperatures.

There is therefore still a need for flame-retardant polymers with improved properties that can be used in different polymer substrates. It is particularly desirable to provide flame-retardant polymers exhibiting a high chemical stability and a good compatibility with thermoplastic base polymers (for example compatibility with respect to solubility or dispersibility) which allows productions of, for example, fibers, molded articles or films from a composition comprising the flame-retardant polymer and the thermoplastic base polymer at high temperatures, such as by melt spinning or other extrusion processes.

Furthermore, it is desirable that the flame-retardant polymer can be distributed homogenously in the base polymer by a simple physical mixing under conditions which are usual in a melt-spinning, extrusion or injection-molding process. The flame-retardant polymer should have low tendency to migrate out of the base polymer and, thus, produce a permanent flame-retarding effect.

Furthermore, there is still a need for flame-retardant polymers which exhibit improved flame-retardant properties compared to known flame retardants. An increased flame-retardant effectivity would allow to either produce an article having improved flame-retardancy using the same amount of flame-retardant polymer or to produce an article having the same flame-retardancy as prior art articles but requiring the incorporation of only less flame-retardant polymer. Reducing the required amount of flame-retardant polymer, minimizes the influence on the physical properties of the base polymer. This ensures reliable processing during extrusion, injection-molding or melt-spinning processes and the following process steps, such as stretching, texturing and dying.

### SUMMARY

The present inventors now found that one or more of the above objects can be achieved by a polymer obtainable by polycondensation of a first monomer, which is an adduct of DOPO with an unsaturated di- or multivalent carboxylic acid, and a phosphorous-containing di- or multivalent alcohol. An aspect of the present invention therefore provides a polymer, obtainable by polycondensation of
a) at least one phosphorous-containing monomer selected from adducts of
   a1) 9,10-dihydro-9-oxa-10-phosphaphenanthrene-10-oxide (DOPO) and/or nuclear substituted DOPO derivatives, with
   a2) at least one unsaturated di- or multivalent carboxylic acid or ester or anhydride thereof;
b) at least one phosphorous-containing di- or multivalent alcohol; and
c) optionally other monomers with the exception of unsaturated di- or multivalent carboxylic acids.

The polymer of the present invention differs from halogen-free DOPO-based flame retardants of the prior art in that the second monomer used in the polycondensation reaction is a phosphorous-containing di- or multivalent alcohol, while in the prior art aliphatic di- and polyvalent alcohols without any additional heteroatoms, and in particular without any additional phosphorous atoms were used. The inventors surprisingly found that incorporation of a phosphorous-containing di- or multivalent alcohol in the polymer increases the flame-retardant properties of the polymer without affecting the compatibility of the polymer with other polymer substrates. This allows reducing the amount of the flame-retardant polymer in a thermoplastic polymer composition without deteriorating the flame-retardant properties of the final product.

Another aspect of the present invention relates to a method of preparing the above flame-retardant polymer by reacting DOPO or a DOPO derivative with an unsaturated di- or multivalent carboxylic acid or ester or anhydride thereof and subsequently with at least one phosphorous-containing di- or multivalent alcohol.

Another aspect of the present invention relates to a thermoplastic polymer composition comprising a thermoplastic polymer and the above flame-retardant polymer.

### DETAILED DESCRIPTION

### Definitions

In the present description, wherein an element or composition is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components.

Further, it should be understood that elements and/or features of an apparatus, a process or method described herein can be combined in a variety of ways without departing from the scope and disclosures of the present teachings, whether explicit or implicit herein.

The term “thermoplastic polymer” shall mean a polymer that becomes pliable or moldable above a specific temperature, so is capable of flow at high temperatures below the thermal decomposition temperature and returns to a solid state upon cooling. A polymer is a macromolecular compound prepared by reacting (i.e., polymerizing, condensation) monomers of the same or different type, including homo- and copolymers. Thermoplastic materials are made by chain polymerization, polyaddition and/or polycondensation.

The term “comprising” includes “consisting essentially of” and “consisting of”.

In the present specification, the description of a range of values for a variable, defined by a bottom limit, or a top limit, or by a bottom limit and a top limit, also comprises the embodiments in which the variable is chosen, respectively, within the value range: excluding the bottom limit, or excluding the top limit, or excluding the bottom limit and the top limit.

In the present specification, the description of several successive ranges of values for the same variable also comprises the description of embodiments where the variable is chosen in any other intermediate range included in the successive ranges. Thus, for example, when it is indicated that “the magnitude X is generally at least 10, advantageously at least 15”, the present description also describes the embodiment where: “the magnitude X is at least 11”, or also the embodiment where: “the magnitude X is at least 13.74”, etc.; 11 or 13.74 being values included between 10 and 15.

In the present specification, the choice of an element from a group of elements also explicitly describes:
the choice of two or the choice of several elements from the group,
the choice of an element from a subgroup of elements consisting of the group of elements from which one or more elements have been removed.

A plurality of elements includes two or more elements.

The phrase ‘A and/or B’ refers to the following selections: element A; or element B; or combination of elements A and B (A+B). The phrase ‘A and/or B’ is equivalent to at least one of A and B. The phrase ‘A and/or B’ equates to at least one of A and B.

The phrase ‘A1, A2, . . . and/or An’ with n >3 includes the following choices: any single element Ai (i=1, 2, . . .n); or any sub-combinations of from two to (n−1) elements chosen from A1, A2, . . ., An; or combination of all elements Ai (i=1, 2, . . . n). For example, the phrase ‘A1, A2, and/or A3’ refers to the following choices: A1; A2; A3; A1+A2; A1+A3; A2+A3; or A1+A2+A3.

The use of the singular ‘a’ or ‘one’ herein includes the plural unless specifically stated otherwise. By way of example, “a multivalent alcohol” denotes one multivalent alcohol or more than one multivalent alcohol.

In addition, if the term “about” or “ca.” is used before a quantitative value, the present teachings also include the specific quantitative value itself, unless specifically stated otherwise. As used herein, the term “about” or “ca.” refers to a +−10% variation from the nominal value unless specifically stated otherwise.

### Flame-Retardant Polymer

One aspect of the present invention relates to a flame-retardant polymer, which is obtainable by polycondensation of
a) at least one phosphorous-containing monomer selected from adducts of
   a1) 9,10-dihydro-9-oxa-10-phosphaphenanthrene-10-oxide (DOPO) and/or nuclear substituted DOPO derivatives, with
   a2) at least one unsaturated di- or multivalent carboxylic acid or ester or anhydride thereof;
b) at least one phosphorous-containing di- or multivalent alcohol; and
c) optionally other monomers with the exception of unsaturated di- or multivalent carboxylic acids.

In a preferred embodiment, the flame-retardant polymer is halogen-free.

It is preferred that the flame-retardant polymer of the invention has a high phosphorous content of above 7.0% by weight. Throughout this description, the phosphorous content is given in % by weight based on the total weight of the polymer. In more preferred embodiments, the polymer has a phosphorous content of at least 7.3% by weight, more preferably at least 7.5% by weight, even more preferably at least 8% by weight, such as at least 9% by weight, and most preferably at least 10% by weight. The upper limit of the phosphorous content in the polymer of the invention is not particularly limited and depends on the monomers used. Generally, the phosphorous content should not be above 18% by weight, preferably at a maximum of 14% by weight, more preferably at a maximum of 13% by weight and even more preferably at a maximum of 12% by weight. The given lower and upper limits of the phosphorous content can be combined with each other. Suitable ranges are, for example, above 7.0% to about 18% by weight and about 7.5% to about 12% by weight. Other combinations of lower and upper limits are possible as well. In preferred embodiments, the phosphorous content is about 7.5% to about 18% by weight, more preferably about 8.0% to about 14% by weight, even more preferably about 9% to about 13% by weight, and most preferably about 10% to about 12% by weight, each of the total weight of the polymer.

In the polycondensation reaction, which makes the polymer of the present invention obtainable, a first phosphorous-containing monomer a) is used. This monomer is an adduct of 9,10-dihydro-9-oxa-10-phosphaphenanthrene-10-oxide (DOPO) and/or nuclear substituted DOPO derivatives with at least one unsaturated di- or multivalent carboxylic acid or ester or anhydride thereof. DOPO has the following chemical structure:

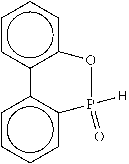

“Nuclear substituted DOPO derivatives” denotes DOPO derivatives which bear one or more substituents on the aromatic rings of DOPO. Each ring may bear 0 to 4 substituents, which can for example be selected from alkyl, alkoxy, aryl, aryloxy and aralkyl. The alkyl moiety in alkyl, alkoxy and aralkyl may have, for example, 1 to 30 carbon atoms, which may be linear, branched or cyclic and which may be saturated or unsaturated, preferably saturated. The aryl in aryl, aryloxy and aralkyl may, for example, comprise 6 to 30 carbon atoms, such as phenyl and naphthyl. If the DOPO molecule bears more than one nuclear substituent, these substituents may be identical or different to each other.

To obtain the first phosphorous-containing monomer a), the DOPO and/or nuclear substituted DOPO derivatives are reacted with at least one unsaturated di- or multivalent carboxylic acid or ester or anhydride thereof to form an adduct.

This adduct formation is shown in the following reaction scheme by way of example using DOPO and itaconic acid as unsaturated dicarboxylic acid. It is, however, to be understood that instead of DOPO, nuclear substituted DOPO derivatives and instead of itaconic acid, other di- or multivalent unsaturated carboxylic acids or esters or anhydrides thereof may be used.

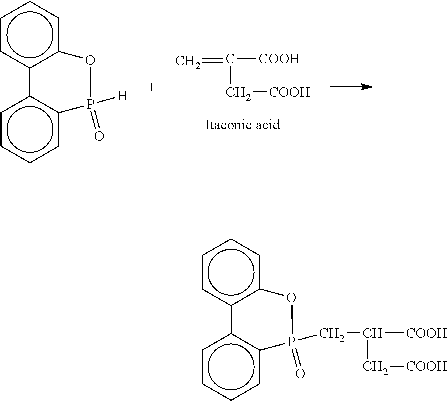

In one embodiment of the present invention, the unsaturated di- or multivalent carboxylic acid or ester or anhydride thereof is a divalent carboxylic acid or ester or anhydride thereof. In a preferred embodiment, the divalent carboxylic acid or ester or anhydride thereof is selected from the group consisting of itaconic acid, maleic acid, fumaric acid, endomethylene tetrathydrophthalic acid, citraconic acid, mesaconic acid, and tetrathydrophthalic acid and esters and anhydrides thereof. Itaconic acid and maleic acid and anhydrides thereof being particularly preferred.

In one embodiment of the present invention, the phosphorous-containing monomer a) can be selected from a compound represented by the following general formula (I):

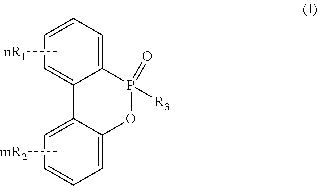

wherein n and m are integers from 0 to 4;
R₁ and R₂ are independently selected from alkyl, alkoxy, aryl, aryloxy and aralkyl, wherein, if more than one of R₁ and/or R₂ are present, each of these substituents can be identical or different to each other; and
R₃ denotes a residue derived from the unsaturated di- or multivalent carboxylic acid or ester or anhydride thereof.

R₁ and R₂ are preferably defined as above with respect to the definition of the nuclear substituted DOPO derivatives. In a preferred embodiment, R₁ and R₂ are independently selected from C₁₋₈ alkyl and C₁₋₈ alkoxy; and n and m are independently 0 or 1.

In order to facilitate a high thermal stability of the final flame-retardant polymer, it is preferred that the first phosphorous-containing monomer a) does not contain any carbon carbon double or triple bonds except aromatic bonds.

Using the above described first phosphorous-containing monomer a), the flame-retardant polymer of the invention can be obtained by polycondensation with at least one phosphorous-containing di- or multivalent alcohol. This polycondensation reaction results in a polyester.

In one embodiment, the phosphorous-containing di- or multivalent alcohol b) is a phosphine oxide. Phosphine oxide has the general formula P(═O)R₄R₅R₆. R₄, R₅ and R₆ can be selected independently from hydrocarbon residues, such as alkyl, aryl, alkylaryl, alkoxyaryl, aralkyl and aryloxyalkyl. Herein, the alkyl residues may for example have 1 to 30 carbon atoms and the aryl residues may have 6 to 30 carbon atoms. Preferred examples of suitable hydrocarbons are C₁₋₄ alkyl, phenyl, naphthalenyl, mono- or di-(C₁₋₄ alkoxy)phenyl and mono- or di-(C₁₋₄ alkoxy)naphthalenyl.

In order to facilitate thermal stability of the flame-retardant polymer of the invention, also the phosphorous-containing di- or multivalent alcohol preferably does not contain any carbon carbon double or triple bonds except aromatic bonds.

The phosphine oxide bears at least two hydroxy groups being attached to the phosphorous atom via the same or different hydrocarbon residues. Thus, the at least two hydroxy groups are attached to the same or different of R₄, R₅ and R₆.

In one embodiment of the present invention, the phosphine oxide is a compound represented by the following general formula (II):

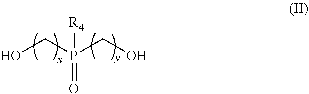

wherein R₄ represents C₁₋₄ alkyl or aryl and x and y are independently 2 or 3. The phosphine oxide of formula (II) wherein R₄ is isobutyl and x and y are both 3 is preferred.

In one embodiment of the present invention, the flame-retardant polymer is obtainable by reacting DOPO with itaconic acid to form the first phosphorous-containing monomer a), which is then reacted with a phosphine oxide of above general formula (II) to form a polyester having repeating units represented by the following general formula (III):

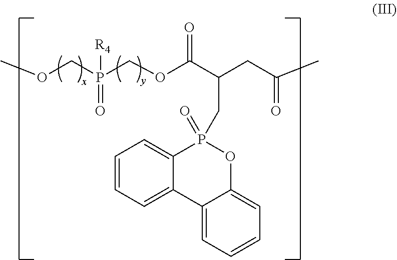

wherein R₄ represents C₁₋₄ alkyl or aryl and x and y are independently 2 or 3, preferably wherein R₄ is isobutyl and x and y are both 3.

The above described flame-retardant polymer may optionally comprise other monomer residues in addition to the first phosphorous-containing monomer a) and the second phosphorous-containing monomer b). These other monomers are not particularly limited as long as they can react with the first monomer a) and the second monomer b) to form a polymer. However, the other monomer is not an unsaturated di- or multivalent carboxylic acid. Preferably, the other monomer does not contain any carbon carbon double or triple bond except aromatic bonds in order to obtain a final flame-retardant polymer of high thermal stability.

The “other monomers” c) can be selected or example from di- and multivalent carboxylic acids and di- or multivalent alcohols, which may or may not comprise phosphorous atoms or other heteroatoms, such as oxygen, nitrogen and sulfur. Other monomers, which can for example form block copolymers with the polyester units of monomers a) and b), may be used.

As a high phosphorous content of the flame-retardant polymer of the invention is desired, the amount of “other monomers” in the polymer should be low, in particular if the other monomers do not contain any phosphorous atoms.

It can therefore be of advantage if, for example, less than 20%, preferably less than 10% and even more preferably less than 5% of the monomer residues of the polymer are residues of “other monomers” c). In a preferred embodiment, the flame-retardant polymer of the invention does not contain any “other monomers” c).

If present, “other monomers” c) can, for example, be selected from carboxyphosphinic acid derivatives, such as carboxyethyl-phenylphosphinic acid (CEPPA) and carboxyethyl-methylphosphinic acid (CEMPA), aminophosphinic acid derivatives making an amide bond by polycondensation, such as aminomethyl phosphinic acid (AMPA), biscarboxyphosphine oxide derivatives, such as bis(beta-carboxyethyl)methylphopsphine oxide (CEMPO), bisaminophosphine oxide derivatives making an amide bond by polycondensation, such as bis(3-aminopropyl)methylphosphine oxide (AMPO), aliphatic diols, such as monoethylene glycol, diethylene glycol, propylene glycol, 1,3-propanediol, 1,3-butandiol, 1,4-butandiol, neopenthyl glycol, hexandiol and 1,10-decandiol, and polyvalent alcohols, such as tri-2-hydroxyethyl isocyanurate (THEIC), glycerol, trimethylolethane, trimethylylpropane, pentaerythrite and sugar alcohols, such as mannitol, multivalent carboxylic acids, such as terephthalic acid, isophthalic acid, phthalic acid, sebacic acid, adipic acid, glutaric acid and succinic acid, as well as hydroxycarboxylic acids, such as lactic acid, glycolic acid, caprolactone and malic acid.

To improve the compatibility with the thermoplastic polymers, the flame-retardant polymer according to the invention can be end-capped by reaction with a monovalent alcohol and/or a monovalent carboxylic acid.

The chemical and physical properties of the polymer according to the invention can be influenced by selecting di- or multivalent monomers. If only divalent monomers are employed, no cross-linking between the polymer backbones occurs. If multivalent monomers are used, cross-linking will occur. By selecting a suitable ratio between di- and multivalent monomers, the degree of cross-linking and thus the properties of the polymer can be tailored.

The average molecular weight Mn of the polymer according to the invention can be above 1,000 g/mol, such as above 3,000 g/mol or even above 4,000 g/mol. For example, the average molecular weight Mn of the polymer according to the invention can be between about 3,000 and about 10,000 g/mol, preferably between about 4,000 and about 8,000 g/mol, more preferably between about 4,000 and about 7,000 g/mol. The average degree of polymerization of the polyester amounts to, for example, at least 10, such as between 10 and 30, preferably between 15 and 25.

In one embodiment, the flame-retardant polymer according to the invention preferably has a low viscosity close to the temperature of spinning of the final thermoplastic polymer composition(such as for example 280° C.) . At this viscosity, an optimum processibility of the polyester in the melt-spinning process and other extrusion processes is obtained. The desired viscosity can be adjusted by an accurate monitoring of the average molecular weight Mn, the average degree of polymerization Pn and/or the degree of cross-linking of the polyester.

The chemical and physical properties of the flame-retardant polymer according to the invention can further be influenced by the temperature and time of polycondensation, the catalyst used and the addition of, for example, chain prolongation and chain cross-linking monomers. Heat stabilizers may also be added.

To improve the color of the flame-retardant polymer according to the invention, it is further possible to use known optical brightening agents. It was furthermore found that the colour of the polymers becomes lighter if the di- or multivalent alcohol is used in excess over the di- or multivalent carboxylic acid in the preparation of the polymers.

A further embodiment of the present invention relates to a method of preparing the above described flame-retardant polymer. This method comprises the steps of
a) reacting 9,10-dihydro-9-oxa-10-phosphaphenanthrene-10-oxide (DOPO) and/or nuclear substituted derivatives thereof with at least one unsaturated di- or multivalent carboxylic acid or ester or anhydride thereof to obtain a first phosphorous-containing monomer;
b) reacting the first phosphorous-containing monomer obtained in step a) with at least one phosphorous-containing di- or multivalent alcohol, and optionally other monomers with the exception of unsaturated di- or multivalent carboxylic acids; and
c) optionally carrying out the reaction in step b) in the presence of at least one monovalent carboxylic acid and/or monovalent alcohol and/or reacting the polymer obtained in step b) with at least one monovalent carboxylic acid and/or monovalent alcohol to obtain an end-capped polymer.

Suitable reaction conditions and in particular polycondensation conditions are known to the person skilled in the art. Useful specific parameters are exemplified in the examples below.

The flame-retardant polymer according to the invention is particularly suitable to impart flame-retardant properties to a thermoplastic polymer composition. Therefore, in a further embodiment, the present invention relates to a thermoplastic polymer composition comprising a thermoplastic polymer and a flame-retardant polymer as described above.

The thermoplastic polymer in the thermoplastic polymer composition can be selected from a broad variety of polymers, in particular synthetic polymers, including homopolymers, copolymers and block copolymers. Also mixtures of one or more thermoplastic polymers may be used. A list of suitable synthetic polymers is, for example, disclosed in WO 2008/119693 A1, the content of which is incorporated herein by reference. Specific examples of suitable thermoplastic polymers are, for example, polyamides, polyphthalamides, polyesters including unsaturated polyester resins, polysulfones, polyimides, polyolefins, polyacrylates, polyether etherketones, acrylnitril butadiene styrenes (ABS), polyurethanes, polystyrenes, polycarbonates, polyphenylene oxides, phenolic resins and mixtures thereof.

In a preferred embodiment, the thermoplastic polymer is a polyamide, such as a polyamide that is suitable for melt spinning or other molding processes. The polyamide can, for example, be selected from the group consisting of PA 6.6, PA 6, PA 6.10, PA 6.12, PA 11 and PA 12. Copolyamides, such as PA 66/6 and blends of polyamides, such as PA 66/PA 6 and PA66/6T are suitable as well.

In another preferred embodiment, the thermoplastic polymer can be a polyester, in particular a polyester which is suitable for melt spinning, such as polyethylene terephthalate.

The amount of flame-retardant polymer in the thermoplastic polymer composition according to the invention is not particularly limited and can be selected by a person skilled in the art according to the requirements. In one embodiment, the thermoplastic polymer composition comprises at least 0.1% by weight, preferably at least 2% by weight of the flame-retardant polymer based on the total weight of the thermoplastic polymer composition. For example, the thermoplastic polymer composition can comprise from about 0.1% to about 30% by weight, preferably from about 2% to about 20% by weight of the flame-retardant polymer, based on the total weight of the thermoplastic polymer composition.

In another embodiment, the thermoplastic polymer composition can comprise the flame-retardant polymer in an amount such that the final thermoplastic polymer composition has a phosphorous content of from about 0.1% to about 5% by weight, preferably of from about 0.1% to about 2% by weight, in particular of from about 0.5 to about 1% by weight, based on the total weight of the thermoplastic polymer composition.

It is also possible to first prepare a master batch of a thermoplastic polymer composition containing a higher phosphorous content of up to, for example, about 8% by weight of the total weight of the composition and then add this master batch to another thermoplastic polymer composition for tailoring its properties. For example, to produce flame-retardant polymer fibers, the flame-retardant polymer according to the invention can physically be mixed with an appropriate polyamide or polyester in the melt, and the mixture is then either directly spun as a polymer mixture having a phosphorous content of between about 0.1% and about 2% by weight, so as to form filaments, or, the mixture is then tailored in terms of a master batch having a phosphorous content of between about 2% and about 8% by weight, and is then added to the same or a different type of polyamide or polyester and spun to filaments in a second process step.

Polymer fibers produced in a melt-spinning process from a thermoplastic polymer composition of the present invention preferably have a total phosphorous content of from about 0.1% to about 2% by weight, in particular of from about 0.5 to about 1% by weight, based on the total weight of the thermoplastic polymer composition, and they are therefore sufficiently flame-proof.

All aforementioned polyamides and polyesters can be finished in an excellent manner to be flame-retarding with the aforementioned flame-retardant polymer by a simple physical mixing of the polymer melts under conditions as are usual in the melt-spinning process. When using the flame-retardant polymer according to the invention, important polymer properties, such as the melt viscosity, the melting point of the polymer composition obtained after mixing are changed only to an extent that a reliable processing, such as a melt spinning remains entirely ensured.

The thermoplastic polymer composition of the present invention may additionally comprise other flame retardants or additives known to a person skilled in the art, in particular those flame retardants and additives which are used in the preparation of fibers. Suitable other flame-retardants are, for example, melamine cyanurate, melamine polyphosphate, ammonium polyphosphate and metal stannates, preferably zinc stannate, metal borates such as zinc borate, polyhedral oligomeric silsesquioxanes (for example trade name POSS of Hybrid Plastics), and so-called nanoclays based on the exfoliated phyllosilicates montmorillonite and bentonite, such as, e.g., the products Nanomer of Nanocor, or Nanofil of Südchemie, and inorganic metal hydroxides such as the products Magnifin or Martinal of Martinswerk. Due to the use of these additives, parameters that are important to the flame-retarding properties can be modified, for example the characteristic cone calorimetric numbers TTI (time to ignition) can be increased, PHRR (peak of heat release rate) can be reduced and/or a desired suppression of the smoke gas generation can be improved.

Both, the flame-retardant polymer as well as the thermoplastic polymer composition according to the invention may comprise additional components, such as anti-dripping agents, polymer stabilizers, anti-oxidants, light stabilizers, peroxide scavengers, nucleating agents, fillers and reinforcing agents, and other additives, such as blend compatibilizing agents, plasticizers, lubricants, emulsifiers, pigments, rheology additives, catalysts, flow-control agents, optical brighteners, flame-proving agents, antistatic agents and blowing agents. Specific examples of these additives are disclosed in WO 2008/119693 A1, the content of which is incorporated herein by reference.

The invention will now be further described by the following examples, which are, however, not to be understood in a limiting sense.

### EXAMPLES

The following starting materials were used for production:

PA66 (Stabamid 26AE1)

Flame retardant: Ukanol FR 80 PU 30 (Schill+Seilacher), containing 8.0%w of phosphorus according to technical data sheet. Ukanol FR 80 is used in US 2013/0136911 A1 as flame retardant. It has the following chemical structure:

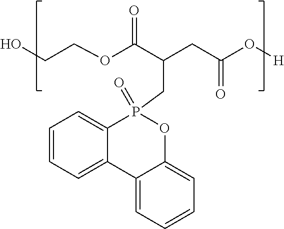

(6-oxide-6H-dibenzo (c,e) (1,2) oxa-phosphorin-6-yl) butanedioic acid (Lunastab DDP, CAS [63562-33-4])

bis(3-hydroxypropyl)isobutylphosphine oxide (Cyagard RF 1243 from Solvay)

The following measuring methods were used:

Melting, crystallization and glass transition temperatures determined by DSC, at 10° C./min.

Onset of thermal degradation temperature determined by TGA, at 10° C./min under nitrogen flow.

Phosphorus content by ICP/OES after sulfonitric mineralization.

Viscosity number in formic acid 90%, according to ISO 307.

UL 94-V with 125×13×3 mm samples.

The acid and hydroxyl numbers were respectively determined by titration in pyridine with NaOH, directly or after reaction with phtalic anhydride.

Phosphorous containing polyester

### Example 1

### Production of a Phosphorous Containing Polyester According to the Invention

276.4 g (0.80 mol) of Lunastab DDP represented by the following formula:

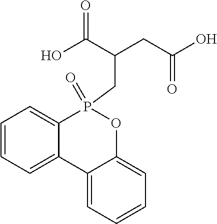 [SMILES: O=C(O)CC(CP1(=O)Oc2ccccc2-c2ccccc21)C(=O)O]

and 178.2 g (0.80 mol) of Cyagard RF 1243 represented by the following formula:

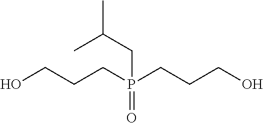

were poured in a one-liter flask equipped with a mechanical stirrer with vacuum/nitrogen inlet and a distillation column followed by a condenser and an internal thermometer. The temperature was increased progressively to 160° C. under nitrogen, with continuous stiffing, and kept for 1 h at this temperature. The temperature was then slowly increased up to 240° C. and kept at this temperature for 3 h and the reaction water thereby produced was continuously removed by distillation. Then the heater was stopped and the adduct was let to cool down to room temperature. The day after the temperature was progressively increased to 160° C. under nitrogen and 0.040 g of tetra-n-butyl titanate in solution in 0.455 g of monoethylene glycol was introduced in the adduct. Then the temperature was increased progressively to 240° C. The column was then removed, and the pressure was reduced to 10 mbar for 4 h, under continuous stiffing. After cooling, a brown glassy polymer was obtained which contained polyester chains represented by the following formula:

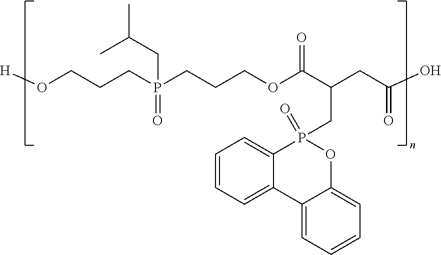

wherein n denotes the mole fraction of the polyester repeating unit. The polymer thus obtained had the following analytical data: The amorphous polyester had a glass transition temperature of 70° C., and a thermal degradation onset of 352° C.

The acid and hydroxyl numbers were respectively 25 mgKOH/g and below 3 mgKOH/g.

The ³¹P NMR was in agreement with the polyester structure, with two chemical shifts at 41 ppm and 59 ppm.

The phosphorous content was 11% w.

Production of PA66 based compounds

### Example 2

### Production of Flame-Retardant PA66 Compound

The PA66 pellets were cryogenic grinded below 1.5 mm and the powder was then dried at 90° C. in a vacuum oven for one night. The polyester from example 1 was roughly dry grinded.

Dry blend was then prepared with the powders of PA66 and polyester according to Example 1 with the corresponding ratio 91.4%/8.6% by weight, for 1% by weight end concentration of phosphorous.

The production of the compound was effected by melt blending with a twin-screw extruder of diameter D=11 mm (L/D =40) equipped by a water cooling bath and a pelletizer. The melt temperature was 260-290° C.

The compound thus obtained had the following analytical data: The melting and crystallization temperatures were respectively 259° C. and 233° C.

The phosphorus content was 1% w.

The viscosity number was 115 mL/g.

### Example 3

### Production of a Phosphorous Containing Polyester According to the Invention

Similarly to example 1, but with 276.4 g (0.80 mol) of Lunastab DDP and 201.7 g (0.91 mol) of Cyagard RF 1243. After cooling, a yellow glassy polymer was obtained, with the following analytical data:

The amorphous polyester had a glass transition temperature of about 65° C., and a thermal degradation onset of 351° C.

The acid and hydroxyl numbers were respectively 15 mgKOH/g and below 3 mgKOH/g.

The ³¹P NMR was in agreement with the polyester structure, with two chemical shifts at 41 ppm and 59 ppm.

The phosphorous content was 12% w.

### Example 4

### Production of a Phosphorous Containing Polyester According to the Invention

Similarly to example 1, but with 276.4 g (0.80 mol) of Lunastab DDP and 216.2 g (0.97 mol) of Cyagard RF 1243. After cooling, a pale yellow glassy polymer was obtained, with the following analytical data:

The amorphous polyester had a glass transition temperature of about 60° C., and a thermal degradation onset of 353° C.

The acid and hydroxyl numbers were respectively 12 mgKOH/g and 6 mgKOH/g.

The ³¹P NMR was in agreement with the polyester structure, with two chemical shifts at 41 ppm and 59 ppm. The phosphorous content was 12% w.

### Comparative Example 1

### Production of a PA66 Compound

Done similarly to Example 2 with 100% by weight of PA66.

The compound thus obtained had the following analytical data:

The melting and crystallization temperatures were respectively 263° C. and 234° C.

The viscosity number was 131 mL/g.

### Comparative Example 2

### Production of a Phosphorous Containing PA66 Compound

Done similarly to Example 2 with the component ratio PA66/Ukanol FR 80 as follow 87.5%/12.5% by weight, for 1% by weight end concentration of phosphorous. The Ukanol FR 80, already in powder, was used as such.

The compound thus obtained had the following analytical data:

The melting and crystallization temperatures were respectively 259° C. and 233° C.

The phosphorus content was 1% w.

The viscosity number was 112 mL/g.

### Flame-Retardancy Test

Prior to flame-retardancy test, the compounds were shaped by melt compression. The comparative examples were selected such that a pure PA66 system (Comp. ex. 1) and a phosphorous containing PA66 system (Comp. ex. 2) were tested. At the same time, example 2 according to the invention was tested, which comprised both PA66 and the flame retardant polyester of the invention (Ex. 1).

The experimental data which verify the positive properties of the described compounds are compiled in Table 1.

TABLE 1

| | Comp. Ex. 1 | Comp. Ex. 2 | Ex. 2 |
|---|---|---|---|
| Composition | | | |
| PA66 (% by weight) | 100.0% | 87.5% | 91.4% |
| FR80 (% by weight) | | 12.5% | |
| Example 1 (% by weight) | | | 8.6% |
| Properties | | | |
| VN (mL/g) | 131 | 112 | 115 |
| Tm (° C.) | 263 | 259 | 259 |
| Tc (° C.) | 234 | 233 | 233 |
| P-content (% by weight) | 0 | 1 | 1 |
| UL 94-V rating | V2 | V2 | V0 |
| t₁ (s) ^{a)} | 2 | 2 | 1 |
| t₂ (s) ^{b)} | 1 | 2 | 1 |
| t_{f} (s) ^{c)} | 16 | 19 | 11 |
| Cotton ignition | Yes | Yes | No |
| Burn up to the holding clamp | No | No | No |

a) Flaming combustion time after first application of the test flame.
b) Flaming and glowing combustion time after the second removal of the test flame.
c) Total flaming combustion time for the 10 flame applications for each set of 5 specimens.

Correspondingly, only example 2, containing the halogen-free flame-retardant polyester according to the invention, has flame-retardant properties which fulfill V0 requirement, the best flame test rating according to UL 94-V, for 3 mm thick samples. In particular the specimens do not drip flaming particles that ignite the dry absorbent surgical cotton located 300 mm below the test specimen.

It can be deduced from comparative example 2 in the table that using Ukanol FR 80 which is known as halogen-free polyester flame retardant in the prior art leads to insufficient flame-retardant properties, even with a higher load of additive, since the specimens drip flaming particles that ignite the dry absorbent surgical cotton located 300 mm below the test specimen. Comparative example 1 with virgin PA66 behaves similarly. Moreover they both show increased total flaming combustion time compared to the example according to the invention.

It can be concluded from these comparative tests that only with the halogen-free flame-retardant polyester of the invention is the flame test according to UL 94-V V0 rated, while thermal characteristics of PA66 are maintained.

### Washing Resistance Test

For the resistance to washing, 2g of pellets obtained in Example 2 or in Comparative example 2 were mixed in 75 g of demineralized water, for 3 h at 95° C., under reflux. Then the pellets were filtered and dried for 2 nights at 90° C., under vacuum. Finally, the remaining phosphorous content was measured. In both cases the phosphorous relative variation was about +/−1% w, which is below the incertitude of the measure itself. Thus no phosphorous content extraction was noticed during the washing resistance test in both cases.

1. A polymer, obtainable by polycondensation of:
a) at least one phosphorous-containing monomer selected from adducts of:
a1) 9,10-dihydro-9-oxa-10-phosphaphenanthrene-10-oxide (DOPO) and/or nuclear substituted DOPO derivatives, with
a2) at least one unsaturated di- or multivalent carboxylic acid or ester or anhydride thereof;
b) at least one phosphorous-containing di- or multivalent alcohol; and
c) optionally other monomers with the exception of unsaturated di- or multivalent carboxylic acids.

2. The polymer according to claim 1 having a phosphorous content of above 7.0% by weight each of the total weight of the polymer.

3. The polymer according to claim 1, wherein the phosphorous-containing monomer a) is selected from a compound represented by the following general formula (I): 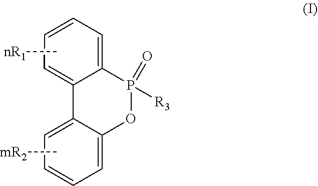
wherein n and m are integers from 0 to 4;
R₁ and R₂ are independently selected from the group consisting of alkyl, alkoxy, aryl, aryloxy and aralkyl, wherein, if more than one of R₁ and/or R₂ are present, each of these substituents can be identical or different to each other; and
R₃ denotes a residue derived from the unsaturated di- or multivalent carboxylic acid or ester or anhydride thereof.

4. The polymer according to claim 3, wherein R₁ and R₂ are independently selected from C₁₋₈ alkyl and C₁₋₈ alkoxy; and n and m are independently 0 or 1.

5. The polymer according to claim 1, wherein the unsaturated di- or multivalent carboxylic acid or ester or anhydride thereof is a divalent carboxylic acid or ester or anhydride thereof which is selected from the group consisting of itaconic acid, maleic acid, fumaric acid, endomethylene tetrahydrophthalic acid, citraconic acid, mesaconic acid, and tetrahydrophthalic acid and esters and anhydrides thereof.

6. The polymer according to claim 5, wherein the unsaturated divalent carboxylic acid is selected from the group consisting of itaconic acid, maleic acid and anhydrides thereof.

7. The polymer according to claim 1, wherein the phosphorous-containing di- or multivalent alcohol b) is a phosphine oxide.

8. The polymer according to claim 7, wherein the phosphine oxide bears at least two hydroxy groups being attached to the phosphorous atom via the same or different hydrocarbon residues.

9. The polymer according to claim 8, wherein the hydrocarbon residues of the phosphine oxide are independently selected from the group consisting of alkyl, aryl, alkylaryl, alkoxyaryl, aralkyl and aryloxyalkyl.

10. The polymer according to claim 7, wherein the phosphine oxide is a compound represented by the following general formula (II): 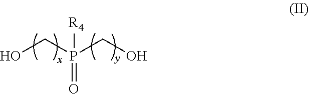
wherein R₄ represents C₁₋₄ alkyl or aryl and x and y are independently 2 or 3.

11. The polymer according to claim 10, wherein R₄ is isobutyl and x and y are both 3.

12. The polymer according to claim 1 comprising repeating units represented by the following general formula (III): 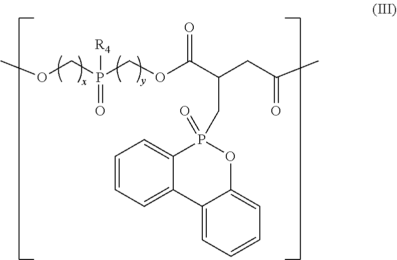
wherein R₄ represents C₁₋₄ alkyl or aryl and x and y are independently 2 or 3.

13. A method of preparing a polymer according to claim 1, wherein the method comprises the steps of:
a) reacting 9,10-dihydro-9-oxa-10-phosphaphenanthrene-10-oxide (DOPO) and/or nuclear substituted derivatives thereof with at least one unsaturated di- or multivalent carboxylic acid or ester or anhydride thereof to obtain a first phosphorous-containing monomer;
b) reacting the first phosphorous-containing monomer obtained in step a) with at least one phosphorous-containing di- or multivalent alcohol, and optionally other monomers with the exception of unsaturated di- or multivalent carboxylic acids; and
c) optionally carrying out the reaction in step b) in the presence of at least one monovalent carboxylic acid and/or monovalent alcohol and /or reacting the polymer obtained in step b) with at least one monovalent carboxylic acid and/or monovalent alcohol to obtain an end-capped polymer.

14. A thermoplastic polymer composition comprising:
a thermoplastic polymer; and
a polymer according to claim 1,
wherein the polymer composition comprises from about 2% to about 20% by weight of the polymer according to claim 1 based on the total weight of the polymer composition, and
wherein the thermoplastic polymer is selected from the group consisting of polyamides, polyphthalamides, polyesters including unsaturated polyester resins, polysulfones, polyimides, polyolefins, polyacrylates, polyether etherketones, acrylnitril butadiene styrenes (ABS), polyurethanes, polystyrenes, polycarbonates, polyphenylene oxides, phenolic resins and mixtures thereof.

15. The polymer of claim 1, wherein the polymer is used as a flame-retardant polymer.

16. The polymer according to claim 9, wherein the hydrocarbon residues of the phosphine oxide are independently selected from the group consisting of C₁₋₄ alkyl, phenyl, naphthalenyl, mono- or di-(C₁₋₄ alkoxy)phenyl and mono- or di-(C₁₋₄ alkoxy)naphthalenyl.
